(19) United States
(12) Patent Application Publication
(10) Pub. No.: US 2025/0093672 A1
(43) Pub. Date: Mar. 20, 2025

(54) ANTI-REFLECTIVE EDGE COATING

(71) Applicant: Applied Materials, Inc., Santa Clara, CA (US)

(72) Inventor: Evan WANG, Palo Alto, CA (US)

(21) Appl. No.: 18/812,828

(22) Filed: Aug. 22, 2024

Related U.S. Application Data
(60) Provisional application No. 63/583,340, filed on Sep. 18, 2023.

(51) Int. Cl. G02B 27/10; G02B 1/11

(52) U.S. Cl. CPC G02B 27/1066; G02B 1/11

(57) ABSTRACT

The present disclosure provides a waveguide combiner and methods thereof. The waveguide combiner includes a substrate having a top surface, a bottom surface, and an edge arrangement. The edge arrangement has at least a first angled surface. The first angled surface includes an angle of about 0.1° to about 90° relative to the top surface or the bottom surface of the substrate. A plurality of structures are disposed over the substrate. An anti-reflection composition is deposited on the first angled surface of the edge arrangement.

### CROSS-REFERENCE TO RELATED APPLICATIONS

This application claims priority to U.S. Provisional Patent Application Ser. No. 63/583,340, filed on Sep. 18, 2023, which is herein incorporated by reference in its entirety.

### BACKGROUND

### Field

Embodiments of the present disclosure generally relate to waveguide combiners for augmented, mixed, and virtual reality.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

One such challenge is displaying a virtual image overlaid on an ambient environment. Waveguide combiners, such as augmented reality waveguide combiners, are used to assist in overlaying images. Generated light is propagated through a waveguide combiner until the light exits the waveguide combiner and is overlaid on the ambient environment. Unfortunately, stray light will often be generated as light will undergo scattering, reflection, and diffraction within the waveguide combiner.

Accordingly, improved waveguide combiners that reduce an amount of stray light is necessitated.

### SUMMARY

The present disclosure provides a waveguide combiner. The waveguide combiner includes a substrate having a top surface, a bottom surface, and an edge arrangement. The edge arrangement has at least a first angled surface. The first angled surface includes an angle of about 0.1° to about 90° relative to the top surface or the bottom surface of the substrate. A plurality of structures are disposed over the substrate. An anti-reflection composition is deposited on the first angled surface of the edge arrangement.

The present disclosure provides a waveguide combiner. The waveguide combiner includes a substrate having a top surface, a bottom surface, and an edge arrangement. The edge arrangement has at least a first angled surface and a second angled surface. The first angled surface includes an angle of about 0.1° to about 90° relative to the top surface of the substrate. The second angled surface includes an angle of about 0.1° to about 90° relative to the bottom surface of the substrate. A plurality of structures are disposed over the substrate. An anti-reflection composition is deposited on the first angled surface of the edge arrangement.

The present disclosure provides a waveguide combiner. The waveguide combiner includes a substrate having a top surface, a bottom surface, and an edge arrangement. The edge arrangement has at least a first angled surface, a second angled surface, and a third angled surface. The first angled surface includes an angle of about 0.1° to about 90° relative to the top surface of the substrate. The second angled surface includes an angle of about 0.1° to about 90° relative to the bottom surface of the substrate. The third angled surface includes an angle of about 0.1° to about 90° relative to the first angled surface or the second angled surface. A plurality of structures are disposed over the substrate. An anti-reflection composition is deposited on the first angled surface of the edge arrangement.

The present disclosure provides methods. The methods include producing a formulation. The formulation is applied on a first angled surface of a waveguide combiner using an edge tool. The first angled surface includes an angle of about 0.1° to about 90° relative to the top surface or the bottom surface of the substrate. The formulation is cured to form an anti-reflection composition.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1A is a perspective, frontal view of a waveguide combiner according to embodiments described herein.

FIG. 1B is a schematic, cross-sectional views of a waveguide combiner having a first edge arrangement according to embodiments described herein.

FIG. 1C is a schematic, cross-sectional views of a waveguide combiner having a second edge arrangement according to embodiments described herein.

FIG. 1D is a schematic, cross-sectional views of a waveguide combiner having a third edge arrangement according to embodiments described herein.

FIG. 2 is a flow diagram of a method of forming an anti-reflection composition on an edge of a waveguide combiner according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

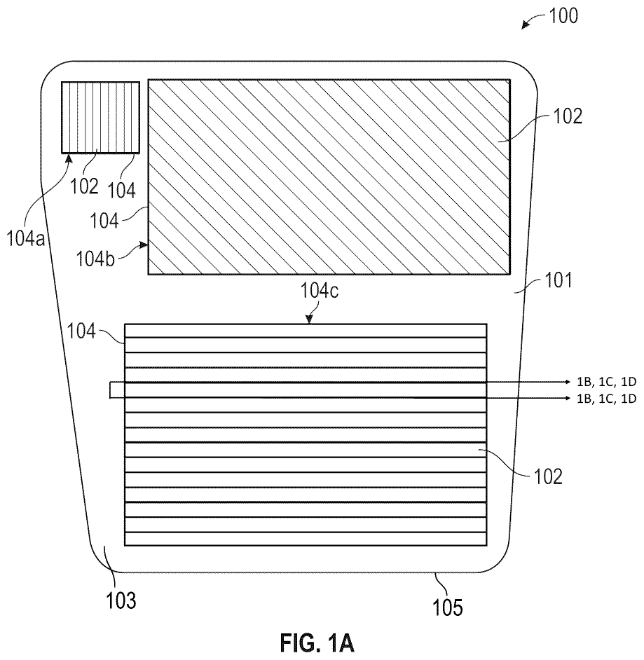

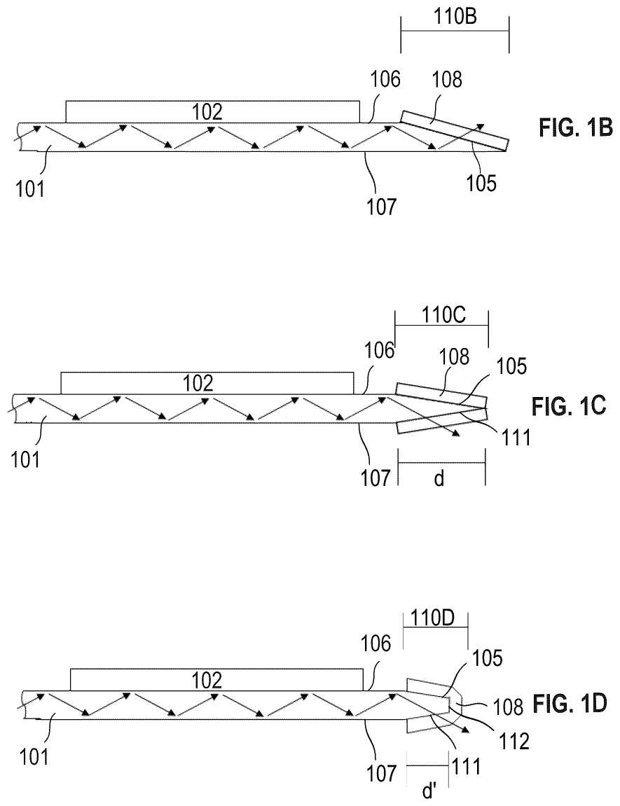

FIG. 1A is a perspective, frontal view of a waveguide combiner 100 according to embodiments. It is to be understood that the waveguide combiner 100 described herein is an exemplary waveguide combiner and other waveguide combiners may allow stray light, e.g., light not diffracted by the one more gratings, to exit a waveguide combiner along a lateral edge of the waveguide combiner, thereby increasing clarity by reducing stray light from reflecting back towards the gratings.

The waveguide combiner 100 includes a plurality of structures 102 disposed on and/or over a surface 103 of a substrate 101. The structures 102 may be nanostructures having sub-micron dimensions, e.g., nano-sized dimensions. The waveguide combiner 100 includes regions of the structures 102 corresponding to one or more gratings 104, such as a first grating 104a, a second grating 104b, and a third grating 104c. The first grating 104a may correspond to an input coupling grating and the third grating 104c corresponding to an output coupling grating. The second grating 104b may correspond to an intermediate grating, e.g., a pupil expander.

The substrate 101 may also be selected to transmit a suitable amount of light of a desired wavelength or wavelength range, such as one or more wavelengths from about 100 to about 3000 nanometers. Without limitation, in some embodiments, the substrate 101 is configured such that the substrate 101 transmits about 50% to about 100% of an infrared to ultraviolet region of the light spectrum. The substrate 101 may be formed from any suitable material, provided that the substrate 101 can adequately transmit light in a desired wavelength or wavelength range and can serve as an adequate support for the waveguide combiner 100 described herein.

The substrate 101 can be any substrate used in the art, and can be either opaque or transparent to a chosen wavelength of light, depending for the use of the substrate 101 as a substrate for a waveguide. Substrate selection may include substrates of any suitable material, including, but not limited to, amorphous dielectrics, non-amorphous dielectrics, crystalline dielectrics, polymers, or combinations thereof. In some embodiments, the substrate 101 includes, but is not limited to, a silicon-containing material, a silicon and oxygen containing compound, a germanium-containing material, a indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, a indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, a sodium and oxygen containing compound, or combinations thereof. In other embodiments, which can be combined with other embodiments described herein, the substrate 101 includes an oxide including one or more of gadolinium, silicon, sodium, barium, potassium, tungsten, phosphorus, zinc, calcium, titanium, tantalum, niobium, lanthanum, zirconium, lithium, or yttrium containing-materials. Example materials of the substrate [reference number] include silicon (Si), silicon monoxide (SiO), silicon dioxide (SiO₂), silicon carbide (SiC), fused silica, diamond, quartz germanium (Ge), silicon germanium (SiGe), indium phosphide (InP), gallium arsenide (GaAs), gallium nitride (GaN), sapphire, sapphire (Al₂O₃), lithium niobate (LiNbO₃), indium tin oxide (ITO), lanthanum oxide (La₂O₃), gadolinium oxide (Gd2O₅), zinc oxide (ZnO), yttrium oxide (Y₂O₃), tungsten oxide (WO₃), titatium oxide (TiO₂), zirconium oxide (ZrO₃), sodium oxide (Na₂O), niobium oxide (Nb₂O₅), barium oxide (BaO), potassium oxide (K2O), phosphorus pentoxide (P₂O₅), calcium oxide (CaO), or combinations thereof.

The substrate 101 may have a refractive index greater than about 1.8. For example, the substrate can include silicon carbide, lithium niobium oxide, and glass having a refractive index of greater than 1.8.

The structures 102 include a structure material. The structure material and the substrate 101 include a different material. The structure material includes, but is not limited to, one or more oxides, carbides, or nitrides of silicon, aluminum, zirconium, tin, tantalum, zirconium, barium, titanium, hafnium, lithium, lanthanum, cadmium, niobium, or combinations thereof. Example materials of the structure material include silicon carbide, silicon oxycarbide, titanium oxide, silicon oxide, vanadium oxide, aluminum oxide, aluminum-doped zinc oxide, indium tin oxide, tin oxide, zinc oxide, tantalum oxide, silicon nitride, zirconium oxide, niobium oxide, cadmium stannate, silicon oxynitride, barium titanate, diamond like carbon, hafnium oxide, lithium niobate, silicon carbon-nitride, silver, cadmium selenide, mercury telluride, zinc selenide, silver-indium-gallium-sulfur, silver-indium-sulfur, indium phosphide, gallium phosphide, lead sulfide, lead selenide, zinc sulfide, molybdenum sulfide, tungsten sulfide, or combinations thereof.

In operation of the waveguide combiner 100 a virtual image is projected from a near-eye display, such as a microdisplay, to the first grating 104a. The structures 102 of the first grating 104a in-couple the incident beams of light of the virtual image and diffract the incident beams to the second grating 104b. The diffracted beams undergo total-internal-reflection (TIR) through the waveguide combiner 100 until the diffracted beams come in contact with structures 102 of the second grating 104b. The diffracted beams from the first grating 104a incident on the second grating 104b are split into a first portion of beams refracted back or lost in the waveguide combiner 100, a second portion beams that undergo TIR in the second grating 104b until the second portion beams contact another structure of the plurality of structures 102 of the second grating 104b, and a third portion of beams that are transmitted through the waveguide combiner 100 to the third grating 104c. The beams of the second portion of beams that undergo TIR in the second grating 104b continue to contact structures of the plurality of structures 102 until either the intensity of the second portion of beams coupled through the waveguide combiner 100 to the second grating 104b is depleted, or remaining portion of the second portion of beams propagating through the second grating 104b reach the end of the second grating 104b.

The beams pass through the waveguide combiner 100 to the third grating 104c and undergo TIR in the waveguide combiner 100 until the beams contact a structure of the plurality of gratings 104 of the third grating 104c. The beams are split into beam fragments that are refracted back or lost in the waveguide combiner 100. Beams undergo TIR in the third grating 104c until the beams contact another structure of the plurality of gratings 104 or the beams are out-coupled from the waveguide combiner 100. The beams that undergo TIR in the third grating 104c continue to contact structures of the plurality of gratings 104 until either the intensity of the beams pass through the waveguide combiner 100 to the third grating 104c is depleted, or a remaining portion of the beams propagating through the third grating 104c have reached the end of the third grating 104c. The beams of the virtual image are propagated from the third grating 104c to overlay the virtual image over the ambient environment.

Some light provided to the waveguide combiner 100 strays from the intended path discussed above. For example, in some instances, a fraction of beams, e.g., stray light, reaches an edge arrangement 110B, 110C, or 110D of the waveguide combiner 100, as shown in FIGS. 1B, 1C, and 1D. While only three configurations of edge arrangements are shown, any number of edge arrangements may be included on the waveguide combiner 100, e.g., curved edge arrangements, multiple angles, or a combination thereof. The edge arrangement 110B, 110C, or 110D of the waveguide combiner 100 may be angled with respect to a top surface 106 or bottom surface 107 of the substrate 101. The edge arrangement 110B, 110C, or 110D of the waveguide combiner 100 may be about 0.1 degrees (°) to about 90° relative to the top surface 106 or the bottom surface 107 of the substrate 101.

FIG. 1B is a schematic, cross-sectional view of a waveguide combiner having a first edge arrangement 110B. In some embodiments, the first edge arrangement 110B may begin about 0 nm to about 30 mm from the plurality of structures 102. The first edge arrangement 110B includes a first angled surface 105. The first angled surface 105 has an anti-reflection composition 108 disposed thereon. The first angled surface 105 may be relative to the top surface 106 of the substrate 101. Optionally the anti-reflection composition 108 may be disposed on the bottom surface of the substrate 101 such that the bottom surface 107 and the first angled surface 105 is coated with the anti-reflection composition 108. The bottom surface 107 extends to intersect the first angled surface 105, as shown in FIG. 1B. The first angled surface 105 may extend about 0.1 mm to about 10 mm.

The first angled surface may include an angle of about 0.1 degrees (°) to about 90° relative to the top surface 106 or the bottom surface 107 of the substrate 101. For example, the first angled surface 105 may include an angle of about 10° to about 45° relative to the top surface 106.

The light may undergo TIR until the light reflects upward towards the first angled surface 105 and transmits out of the substrate 101. Alternatively, the first angled surface 105 may be relative to the bottom surface 107 of the substrate 101, in which the top surface 106 extends to intersect the first angled surface 105. The light may undergo TIR until the light reflects downwards towards the first angled surface 105.

FIG. 1C is a schematic, cross-sectional view of a waveguide combiner having a second edge arrangement 110C. The second edge arrangement 110C includes a first angled surface 105 and a second angled surface 111. The first angled surface 105 has an anti-reflection composition 108 disposed thereon. The second angled surface 111 has an anti-reflection composition 108 disposed thereon. The first angled surface 105 may be relative to the top surface 106 of the substrate 101 and the second angled surface 111 may be relative to the bottom surface 107 of the substrate 101. Optionally the anti-reflection composition 108 may be disposed on the bottom surface of the substrate 101 such that the bottom surface 107, the first angled surface 105, and the second angled surface 111 is coated with the anti-reflection composition 108. The second angled surface 111 may extend about 0.1 mm to about 10 mm.

The first angled surface 105 and/or the second angled surface 111 may independently include an angle of about 0.1 degrees (°) to about 90° relative to the top surface 106 or the bottom surface 107 of the substrate 101. For example, the first angled surface 105 may include an angle of about 10° to about 45° relative to the top surface 106, and the second angled surface 111 may include an angle of about 10° to about 45° relative to the bottom surface 111.

The first angled surface 105 and the second angled surface 111 may intersect at some distance d from the top surface 106 and the bottom surface 107. The light may undergo TIR until the light reflects upward or downward towards the edge arrangement 110C having both the first angled surface 105 and the second angled surface 111.

FIG. 1D is a schematic, cross-sectional view of a waveguide combiner having a third edge arrangement 110D. The third edge arrangement 110D includes a first angled surface 105, a second angled surface 111, and a third angled surface 112. The first angled surface 105 has an anti-reflection composition 108 disposed thereon. The second angled surface 111 has the anti-reflection composition 108 disposed thereon. The third angled surface 112 has the anti-reflection composition 108 disposed thereon. The first angled surface 105 is relative to the top surface 106 of the substrate 101, the second angled surface 111 is relative to the bottom surface 107 of the substrate 101, and the third angled surface 112 may be relative to the first angled surface 105 or the second angled surface 111, as shown in FIG. 1D. Optionally the anti-reflection composition 108 may be disposed on the bottom surface of the substrate 101 such that the bottom surface 107, the first angled surface 105, the second angled surface 111, and the third angled surface 112 is coated with the anti-reflection composition 108. The third angled surface 112 may extend about 0.0 mm to about 10 mm. The first angled surface 105 and the second angled surface 111 may intersect the third angled surface 112 at some distance d′, in which the third angled surface 112 may extend such that the third angled surface 112 intersects both the first angled surface 105 and the second angled surface 111.

The first angled surface 105, the second angled surface 111, and the third angled surface 112 may independently include an angle of about 0.1 degrees (°) to about 90° relative to the top surface 106 or the bottom surface 107 of the substrate 101. For example, the first angled surface 105 may include an angle of about 10° to about 45° relative to the top surface 106, the second angled surface 111 may include an angle of about 10° to about 45° relative to the bottom surface 107, and the third angled surface 112 may include an angle of about 80° to about 90° relative to the first angled surface 105 and/or the second angled surface 111.

The light may undergo TIR until the light reflects upward or downward towards the third edge arrangement 110D having the first angled surface 105, the second angled surface 111, and the third angled surface 112.

Upon reaching the edge arrangement 110B, 110C, or 110C, the stray light may be (1) transmitted through the edge arrangement, (2) reflected, or scattered, through the waveguide combiner 100 at a variety of angles, or (3) absorbed at the edge arrangement. Without being bound by theory, an angled surface that has an angle that is less than 90° relative to the top surface 106 or the bottom surface 107 may increase the amount of light that is transmitted through the edge arrangement, preventing light from being reflected, or scattered, through the waveguide combiner 100 at a variety of angles. By preventing reflection and/or scattering, prevention of ghost images or background haze may occur due to the light not reflecting back towards the structures 102 of the waveguide combiner 100.

An anti-reflection composition 108 is disposed along the edge arrangement 110B, 110C, or 110D to reduce an amount of external light that enters through the first angled surface 105, second angled surface 111, or third angled surface 112, and to reduce an amount of stray light that is scattered or reflected back towards the waveguide combiner 100. The anti-reflection composition 108 may be composed of one or more of silicon oxide, aluminum oxide, titanium oxide, niobium oxide, silicon nitride, or a polymer. The anti-reflection composition 108 may be about 60% to about 99% translucent. The anti-reflection composition 108 may be translucent and/or imperceptible, in which the edge arrangement 110B, 110C, or 110D can appear colorless or of the same material as the substrate 101. The anti-reflection composition 108 may include a refractive index that is between the refractive index of air and the substrate 101, e.g., about 1.3 to about 1.7. An anti-reflection composition 108 that is translucent or imperceptible may allow for enhanced visuals to be presented due to the lack of a perceived frame or perceived edge of the substrate 101. Additionally, an anti-reflection composition 108 that is translucent or imperceptible may allow for frameless or edge free optical devices to be produced.

The anti-reflection composition 108 may include one or more types of particles, at least one of one or more dyes or one or more pigments, and a polymer matrix of one or more binders. In some embodiment, the anti-reflection composition 108 further includes one or more filler dispersions, one or more photoinitiators, one or more epoxy resins, one or more additives, one or more silanes, one or more isocyanates, one or more acids, one or more phosphine oxides, or combinations thereof. Examples of the filler dispersions include acrylates or methacrylates. Examples of the additives include amines or amides. Example of the dyes include organic dyes. The one or more pigments include, but are not limited to, carbon black, carbon nanotubes, iron oxide black, black pigments, or combinations thereof. The one or more binders, as described herein in a method 200 of forming an anti-reflection composition 108 on an edge arrangement 110B, 110C, or 110D of a waveguide combiner 100, are operable to be cured by radiation, to form a polymer matrix, as described below. The one or more types of particles are disposed in the polymer matrix. The one or more binders include, but are not limited to, a UV curable binder, a LED curable binder, a thermal curable binder, an infrared curable binder, or combinations thereof.

The one or more types of particles include, but are not limited to, titanium oxide (TiO₂), Si, zirconium oxide (ZrO₂), zinc oxide (ZnO), ferrosoferric oxide (Fe₃O₄), germanium (Ge), SiC, diamond, dopants thereof, or any combination thereof. The one or more types of particles includes at least of nanoparticles or microparticles. Each nanoparticle (NP) or microparticle (MP) can be a coated particle, such as one, two, or more shells disposed around a core. In some examples, the NPs or MPs can contain one or more types of ligands coupled to the outer surface of the NPs or MPs (e.g., ligated NPs or stabilized NPs). The NPs or MPs can have one or more different shapes or geometries, such as spherical, oval, rod, cubical, wire, cylindrical, rectangular, or combinations thereof. The NPs can have a size or a diameter of about 2 nm to about 200 nm.

A particle refractive index of the one or more types of particles may be between the refractive index of air and the refractive index of the substrate 101. In some embodiments, which can be combined with other embodiments described herein, the particle refractive index of the one or more types of particles is about 1.3 to about 1.7. The particle refractive index of about 1.3 to about 1.7 provide for the anti-reflection composition 108 having a refractive index of about 1.3 to about 1.7 or greater. The optical density of the anti-reflection composition 108 may be transparent Without being bound by theory, a particle refractive index of about 1.3 to about 1.7 can reduce the amount of stray light transmitted through the edge arrangement 110B, 110C, or 110D, and the amount of stray light scattered in the waveguide combiner 100 by the edge arrangement 110B, 110C, or 110D, by allowing the light to transmit through the edge arrangement 110B, 110C, or 110D. The refractive index of about 1.3 to about 1.7 of the anti-reflection composition 108 is disposed on high refractive index substrates, e.g., substrates having a refractive index greater than about 1.8, to provide for further absorption of stray light. The anti-reflection composition 108 formed by the method 200 described herein utilizes a formulation that provides for a viscosity, surface tension, chemical and physical stability, and environmental reliability such that the formulation is operable to be applied to first angled surface 105, second angled surface 111, or third angled surface 112 with an edge tool and remain on the first angled surface 105, second angled surface 111, or third angled surface 112 prior to curing.

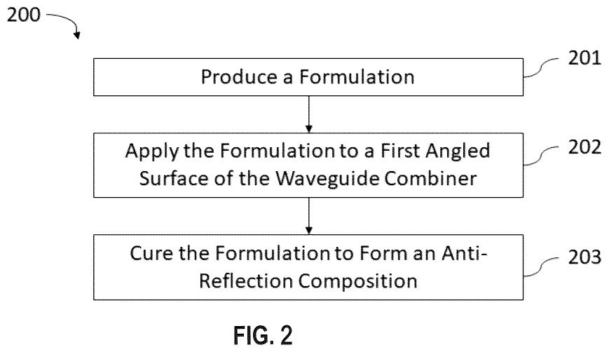

FIG. 2 is a flow diagram of a method 200 of forming an anti-reflection composition 108 on a first angled surface 105, a second angled surface 111, and/or a third angled surface 112 of a waveguide combiner 100. To facilitate explanation, the method 200 will be described with reference to the waveguide combiner 100 of FIG. 1. However, it is to be noted that the waveguide combiner 100 is an exemplary waveguide combiner and other waveguide combiners may have an edge coated with the anti-reflection composition 108 in conjunction with method 200.

At operation 201, a formulation is produced. The formulation includes one or more types of particles, at least one of one or more dyes or one or more pigments, one or more binders, and one or more solvents. The formulation may further include one or more filler dispersions, one or more photoinitiators, one or more epoxy resins, one or more additives, one or more silanes, one or more isocyanates, one or more acids, one or more phosphine oxides, or combinations thereof. The one or more solvents are operable to evaporate or vaporize upon application on the formulation to the first angled surface 105, the second angled surface 111, or the third angled surface 112 of the waveguide combiner 100. The formulation provides for a viscosity, surface tension, chemical and physical stability, and environmental reliability such that the formulation is operable to be applied to the first angled surface 105, the second angled surface 111, or the third angled surface 112 with an edge tool and remain on the first angled surface 105, the second angled surface 111, or the third angled surface 112 prior to curing. The formulation may have a viscosity of about 1 kcP to 100 kcP.

At operation 202, the formulation is applied to the first angled surface 105, second angled surface 111, or third angled surface 112 of the waveguide combiner 100. The formulation may be applied with an edge tool. In one example, the edge tool includes a substrate support operable to retain a substrate, a first actuator configured to rotate the substrate support; a holder configured to hold a coating applicator against the first angled surface 105, second angled surface 111, or third angled surface 112 of the substrate 101 when the substrate 101 is rotated on the substrate support, a second actuator operable to apply a force on the holder in a direction towards the substrate support to apply the formulation to the first angled surface 105, second angled surface 111, or third angled surface 112.

The one or more solvents evaporate or vaporize and the one or more types of particles, at least one of one or more dyes or one or more pigments, one or more binders remain. At operation 203, the formulation is cured to form the anti-reflection composition 108 on the first angled surface 105, second angled surface 111, or third angled surface 112 of the waveguide combiner 100. The one or more binders are cured by radiation to form a polymer matrix. In some embodiments, the anti-reflection composition 108 is cured to form a thickness of the anti-reflection composition 108 over the first angled surface 105, second angled surface 111, or third angled surface 112 that is about 50 nm to about 200 nm. The one or more types of particles are disposed in and supported by the polymer matrix. The one or more binders include, but are not limited to, a UV curable binder, a LED curable binder, a thermal curable binder, an infrared curable binder, or combinations thereof. Thus, the cure process of operation 203 includes a UV cure process, a LED cure process, a thermal cure process, an infrared cure process, or a combination thereof.

Overall, a waveguide combiner having an edge arrangement coated with an anti-reflection composition and a method of coating the edge arrangement of the waveguide combiner with the anti-reflection composition are described herein. The waveguide combiner of the present disclosure has an angled surface that is less than 90° relative to a the top surface or the bottom surface which increases the amount of light that is transmitted through the edge arrangement and prevents ghost images or background haze from being emitted by the waveguide combiner due to back scattering. Additionally, the waveguide combiner of the present disclosure allows for enhanced visuals to be displayed due to the lack of a perceived frame or perceived edge of the substrate using the anti-reflection composition. Accordingly, the waveguide combiner of the present disclosure will have improved aesthetics compared to waveguide combiners that lack an edge arrangement having a first angled surface and/or an anti-reflection composition.

While the foregoing is directed to examples of the present disclosure, other and further examples of the disclosure may be devised without departing from the basic scope thereof, and the scope thereof is determined by the claims that follow.

1. A waveguide combiner, comprising:
a substrate having a top surface, a bottom surface, and an edge arrangement, the edge arrangement having at least a first angled surface,
wherein the first angled surface comprises an angle of about 0.1° to about 90° relative to the top surface or the bottom surface of the substrate;
a plurality of structures disposed over the substrate; and
an anti-reflection composition deposited on the first angled surface of the edge arrangement.

2. The waveguide combiner of claim 1, wherein the first angled surface extends about 0.1 mm to about 10 mm.

3. The waveguide combiner of claim 1, wherein the edge arrangement has a first angled surface and a second angled surface.

4. The waveguide combiner of claim 3, wherein the second angled surface extends about 0.1 mm to about 10 mm.

5. The waveguide combiner of claim 3, wherein the first angled surface is relative to the top surface and the second angled surface is relative to the bottom surface.

6. The waveguide combiner of claim 3, wherein the edge arrangement has a first angled surface, a second angled surface, and a third angled surface.

7. The waveguide combiner of claim 6, wherein the third angled surface extends about 0.1 mm to about 10 mm.

8. The waveguide combiner of claim 6, wherein the first angled surface is relative to the top surface, the second angled surface is relative to the bottom surface, and the third angled surface is relative to the first angled surface or second angled surface.

9. The waveguide combiner of claim 8, wherein the third angled surface intersects the first angled surface and the second angled surface.

10. A waveguide combiner, comprising:
a substrate having a top surface, a bottom surface, and an edge arrangement, the edge arrangement having a first angled surface and a second angled surface,
wherein the first angled surface comprises an angle of about 0.1° to about 90° relative to the top surface of the substrate, and
wherein the second angled surface comprises an angle of about 0.1° to about 90° relative to the bottom surface of the substrate;
a plurality of structures disposed over the substrate; and
an anti-reflection composition selectively deposited on the first angled surface and the second angled surface of the edge arrangement.

11. The waveguide combiner of claim 10, wherein the second angled surface extends about 0.1 mm to about 10 mm.

12. The waveguide combiner of claim 10, wherein the edge arrangement has a first angled surface, a second angled surface, and a third angled surface.

13. The waveguide combiner of claim 12, wherein the third angled surface extends about 0.1 mm to about 10 mm.

14. The waveguide combiner of claim 12, wherein the first angled surface is relative to the top surface, the second angled surface is relative to the bottom surface, and the third angled surface is relative to the first angled surface or second angled surface.

15. The waveguide combiner of claim 14, wherein the third angled surface intersects the first angled surface and the second angled surface.

16. A waveguide combiner, comprising:
a substrate having a top surface, a bottom surface, and an edge arrangement, the edge arrangement having a first angled surface, a second angled surface, and a third angled surface;
wherein the first angled surface comprises an angle of about 0.1° to about 90° relative to the top surface of the substrate,
wherein the second angled surface comprises an angle of about 0.1° to about 90° relative to the bottom surface of the substrate, and
wherein the third angled surface comprises an angle of about 0.1° to about 90° relative to the top first angled surface or the second angled surface;
a plurality of structures disposed over the substrate; and
an anti-reflection composition selectively deposited on the first angled surface, the second angled surface, and the third angled surface of the edge arrangement.

17. The waveguide combiner of claim 16, wherein the third angled surface extends about 0.1 mm to about 10 mm, and wherein the third angled surface intersects the first angled surface and the second angled surface.

18. A method, comprising:
producing a formulation;
applying the formulation on a first angled surface of a waveguide combiner using an edge tool, wherein the first angled surface comprises an angle of about 0.1° to about 90° relative to a top surface or a bottom surface of a substrate of the waveguide combiner; and
curing the formulation to form an anti-reflection composition.

19. The method of claim 18, further comprising applying the formulation on a second angled surface of the waveguide combiner, wherein the second angled surface comprises an angle of about 0.1° to about 90° relative to the bottom surface of the substrate.

20. The method of claim 19, further comprising applying the formulation on a third angled surface of the waveguide combiner, wherein the third angled surface comprises an angle of about 0.1° to about 90° relative to the first angled surface or the second angled surface.
